(19) United States
(12) Patent Application Publication
(10) Pub. No.: US 2006/0274351 A1
(43) Pub. Date: Dec. 7, 2006

(54) System and method for tracking conditions during document processing operations

(76) Inventors: Brenda F. Daos, Mission Viejo, CA (US); Vincent Wu, Irvine, CA (US); Rohit Wadhwa, Lebanon, NH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/142,870

(22) Filed: Jun. 2, 2005

(51) Int. Cl. G06K 15/00; G06F 15/00

(52) U.S. Cl. 358/1.14; 358/1.15

(57) ABSTRACT

A system and method for tracking errors in a document processor during document processing operations. The system uses a job monitor that monitors the document processing operations performed by an associated document processing device. The job monitor periodically receives job status data indicating the status of the job being processed. When the job status indicates that an interruption in the processing of the job has occurred, an alert notification message is generated. The alert notification message includes the name of the job interrupted, the type of interruption, and the amount of the job completed prior to the interrupt. The alert notification message is then transmitted to a designated destination corresponding to a user application from which the job originated or to a system administrator application.

### BACKGROUND OF THE INVENTION

This invention is directed to a system and method for document processing. More particularly, this invention is directed to a system and method for tracking errors during document processing operations.

Document processing devices, including multifunction peripheral devices, are typically employed over a network and used by a variety of applications. When an application, such as a web browser or word processing program, forwards an electronic file to the document processing devices, errors sometimes occur. Examples of such errors include the toner level in the multifunction peripheral being empty, a paper jam has occurred, and the like. Current embodiments of document processing devices do not report the number of pages output prior to the error occurring. Thus, there are no means for an application to determine at which point in the document processing an error occurred. Furthermore, there are no means for the application to determine where to restart the document processing operation, absent user or administrator involvement.

There exists a need for a system and method for tracking document processing errors.

### SUMMARY OF THE INVENTION

In accordance with the present invention, there is provided a system and method for document processing.

Further, in accordance with the present invention, there is provided a system and method for tracking errors during document processing operations.

Still further, in accordance with the present invention, there is provided a system and method for tracking and reporting errors that occur during document processing operations.

Still further, in accordance with the present invention, there is provided a document processor error tracking system. The system includes a job monitor associated with the document processor. The job monitor includes receiving means adapted to receive job data corresponding to the status of a job processing operation being performed by the document processor. The job monitor further includes receiving means adapted to receive a job interrupt signal representing the interruption of a document processing operation. The system also includes an alert generator. The alert generator generates an alert message, including the job status data, in response to the job interrupt signal. The system also includes communication means adapted to selectively communicate the alert message to at least one selected destination.

Still further, in accordance with the present invention, there is provided a method for tracking document processor error. The method begins by receiving job status data representing the status of a document processing operation being processed on the document processor. Next, a job interrupt signal is received. The job interrupt signal represents an interruption in the document processing operation prior to the job's completion. An alert message is then generated in response to the received job interrupt signal. The alert message includes the status data corresponding to the job being processed. The alert message is then selectively communicated to at least one selected destination.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating an error tracking method in accordance with the present invention;

FIG. 3 is a flow chart illustrating a registration and notification method employed by applications in accordance with the present invention; and

FIG. 4 is a template screen illustrating an alert message in accordance with the present invention.

### DETAILED DESCRIPTION OF THE PREFERRED EMBODIMENTS

The present invention is directed to a system and method for document processing. More particularly, the present invention is directed to a system and method for tracking errors on a document processor during document processing operations.

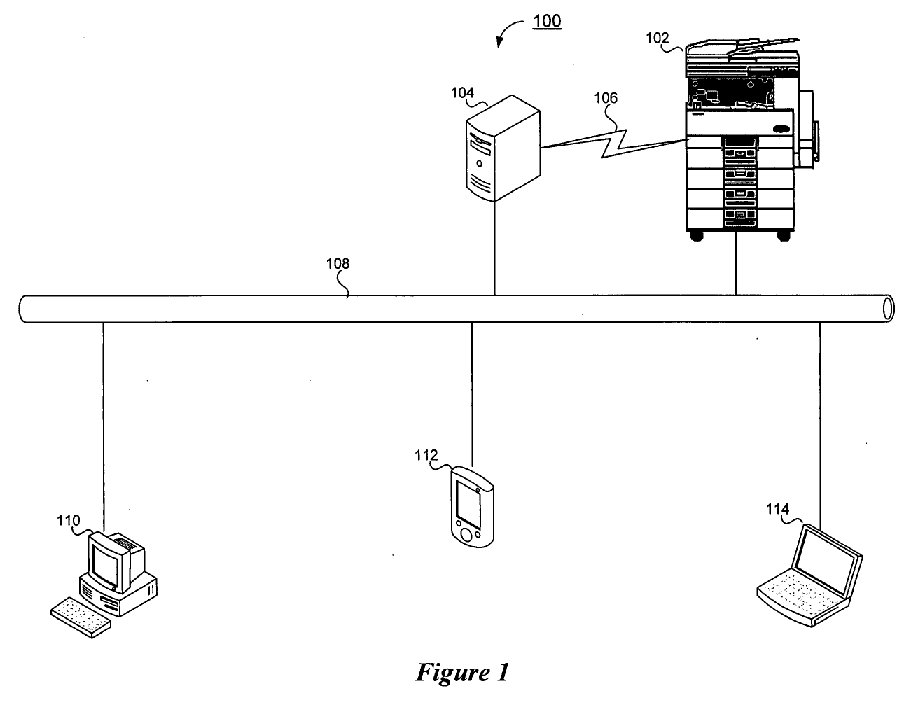

Turning now to FIG. 1, there is shown a diagram illustrating the system 100 in accordance with the present invention. As shown in FIG. 1, a user is able to access a document processing device, illustrated by a multifunction peripheral device 102, to generate or process image data. Those skilled in the art will appreciate that the document processing device is any suitable document processing device known in the art, such as a copier, printer, scanner, facsimile, multifunctional peripheral device and the like, or any combination thereof. Suitable commercially available document processing devices include, but are not limited to, the Toshiba e-Studio Series Controller. Preferably, the document processing device 102 is communicatively coupled to a job monitor 104. As will be appreciated by those skilled in the art, the job monitor 104 is any suitable software, hardware, or any combination thereof, in data communication with the document processing device 102. In one embodiment, the job monitor 104 communicates with the document processing device 102 via a suitable communications link 106. The communications link 106 is any suitable means of communication between two electronic devices, including without limitation, an Ethernet based network connection, infrared connection, Wi-Fi connection, an IEEE802.11(x) wireless connection, telephone connection, cellular connection, Bluetooth connection and the like or any combination of communication means thereof.

The skilled artisan will appreciate that the job monitor 104 is illustrated in FIG. 1 as being located external to the document processing device 102, however, the job monitor 104 is suitably adapted to be implemented in an internal configuration. Those skilled in the art will understand that the job monitor 104 is shown in FIG. 1 for ease of explanation and not to limit the present invention thereto. The job monitor 104 and the document processing device 102 are suitably connected to a computer network 108. As will be understood by those skilled in the art, the computer network 108 is any computer network that facilitates communication between multiple electronic devices. For example, and without limitation, the computer network 108 is capable of being a local area network, a wide area network, the Internet, and the like. Also communicatively coupled to the computer network 108 are user devices, illustrated in FIG. 1 as a personal computer 110, a personal data assistant 112 and a laptop computer 114. The skilled artisan will appreciate that other personal electronic devices, capable of interaction with the computer network 108 are also adaptable to being implemented by the present invention and the selected user devices 110-114 are for example purposes only.

In the preferred embodiment, each of the user devices 110-114 suitably includes an application residing thereon, to enable communication with the document processing device 102. More preferably, each of the applications of the user devices 110-114 advantageously register with the job monitor 104 via any means known in the art. The skilled artisan will appreciate that such registration enables the job monitor 104 to selectively communicate with the user devices 110-114. In operation, the job monitor 104 suitably tracks the progress of each document processing job submitted to the document processing device 102 for processing. The job monitor 104 begins by querying the document processing device 102 for those jobs pending. For example, the job monitor 104 receives the job identification or names for each job submitted, the type of processing to be performed, the progress of any processing, and the like. The document processing device 102 suitably transmits such information to the job monitor 104 via the communications link 106. It will be understood by those skilled in the art that in the case of an internally configured job monitor 104, i.e., a job monitor 104 represented as software residing on the document processing device 102, or an integrated hardware component connected thereto, such a communications link 106 is capable of being any data transmission bus known in the art.

Upon receipt of the job identifications corresponding to the jobs being processed by the document processing device 102, the job monitor 104 monitors the status of each of the jobs being so processed at predetermined intervals. When a job interrupt occurs, the document processing device 102 suitably generates an interrupt signal indicating the occurrence of the job interrupt. The job monitor 104 gathers the details associated with the interrupt and generates a log file indicating the name of the job, the nature of the interrupt, time and date data, page data, and the like. It will be understood by those skilled in the art that a job interrupt is capable of being any document processing error known in the art, including and without limitation, a mechanical error, a software error, an electrical error, and the like. The skilled artisan will appreciate that paper jams, out of paper problems, toner level problems, disconnect during facsimile operations, automatic document feeder jam, incompatible processing requirements, and the like all represent interrupts in accordance with the present invention.

In addition to recording the job interrupt in a log file, the job monitor 104 generates a job interrupt notification message. In accordance with the present invention, the job interrupt notification message suitably includes, but is not limited to, the name of the job interrupted, the nature of the interrupt, the time and date, the number of pages printed, the number of copies made, the number of pages scanned, the number of pages transmitted via fax or email, and the like. It will be appreciated by those skilled in the art that the data contained in the job interrupt notification message suitably matches the job interrupt data stored in the log file. Preferably, the notification message is advantageously an extensible markup language (“XML”) formatted message. Those skilled in the art will appreciate that other formats are equally capable of being used without departing from the scope of the present invention. Once the message has been generated by the job monitor 104, the message is transmitted via the computer network 108 to those applications registered to receive the notification. For example, the applications that are the designated recipients of the notification suitably include, but are not limited to, a system administrator application, the application that originated the job, applications that have pending jobs remaining to be processed by the document processing device 102, all registered applications, and the like.

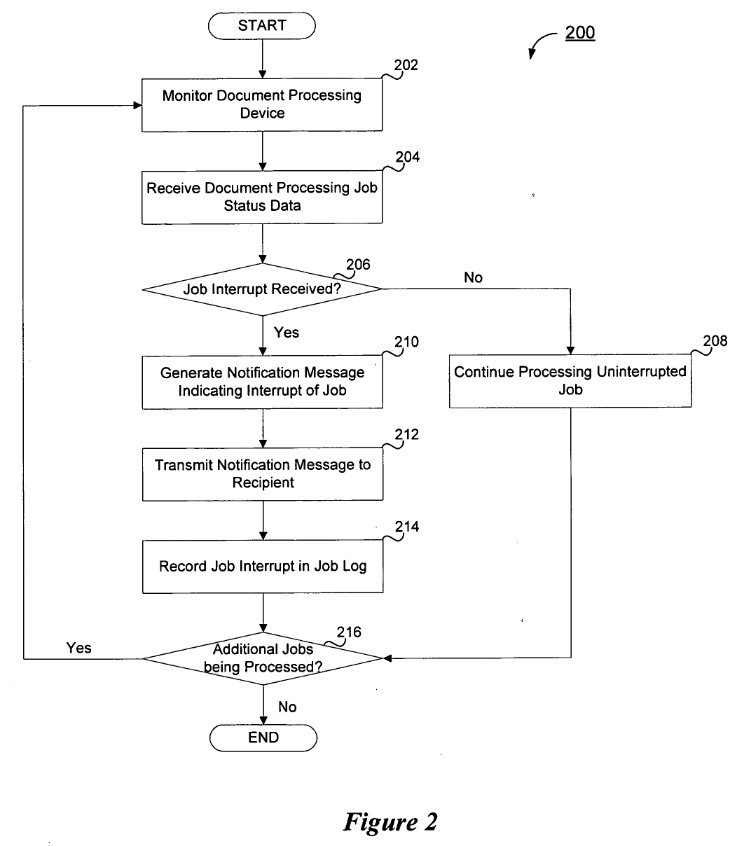

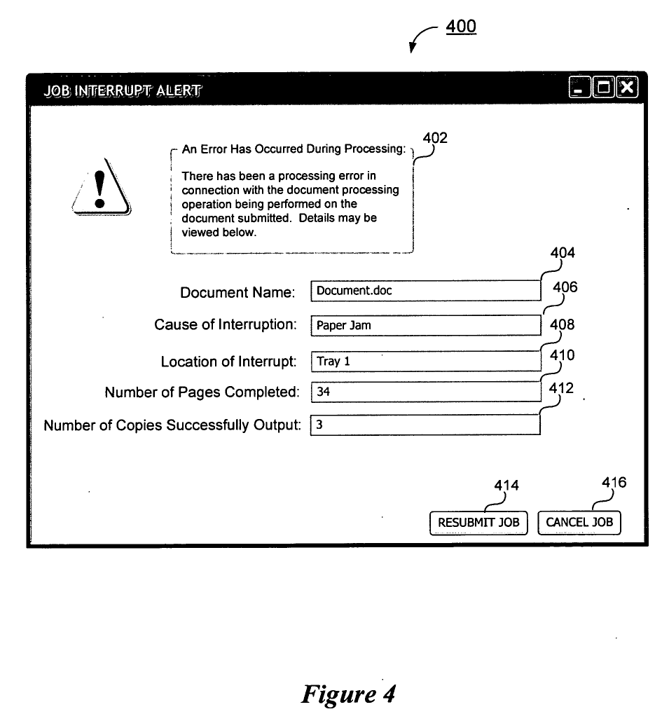

It will be appreciated by those skilled in the art that the applications which receive the job interrupt notification message are suitably capable of generating an alert message indicative of the job interrupt to a designated user or system administrator. Preferably, the alert message is displayed to the designated user or administrator via any means known in the art, including, without limitation, an electronic mail message, an SNMP message, a text alert message, and the like. An example of an alert message is discussed below with respect to FIG. 4. More preferably, the alert message suitably includes the same or similar data reflected in the job interrupt notification message and corresponding log file. The user or administrator is able to view, export, email, and print the logs of jobs that were interrupted due to paper jams and other such errors. The skilled artisan will appreciate that such capabilities will assist in the troubleshooting, prevention and service of the document processing device 102. The system 100 will best be understood in accordance with the method described in FIG. 2.

Turning now to FIG. 2 there is shown a flowchart 200 illustrating the job monitoring method in accordance with the present invention. The method begins at step 202 by monitoring the document processing device 102. Preferably, the job monitor 104 is suitably in data communication with the document processing device 102 to facilitate the job interrupt notification in accordance with the present invention. At step 204, the job monitor 104 receives, from the document processing device 102, document processing job data representing the status of a job being processed. A determination is then made at step 206 whether the received status data indicates that a job interrupt has occurred. As will be appreciated by those skilled in the art, the job interrupt is capable of including, but is not limited to, a software processing error of image data, an out of toner error, a paper jam error, an out of paper error, a transmission termination error, a paper feed error, and the like. When it is determined that the status data fails to indicate a job interrupt, flow proceeds to step 208, wherein the document processing operation continues unimpeded.

When it is determined that a job interrupt signal has been received, i.e., a job interrupt has occurred, flow proceeds to step 210, wherein a notification message is generated indicting the interruption of the job prior to completion of the document processing operation. As previously mentioned, the notification message preferably includes data representing the name of the document job being processed, the nature of the interrupt, the number of pages printed, the number of pages remaining to be printed, the number of copies made, and the like. More preferably, the notification message is suitably generated in XML format, enabling cross-platform communications between applications and the job monitor 104, although the skilled artisan will appreciate that other file formats are equally capable of being implemented without departing from the scope of the present invention. Those skilled in art will appreciate that the job monitor 104 is capable of including other pertinent information regarding the interruption of the job in addition to those mentioned above. The notification message is then transmitted at step 212 to the designated recipient application via any means known in the art. Preferably, the notification message is broadcast over the computer network 108 to the designated recipient. In the preferred embodiment, the designated recipient application is one of the group of applications that have registered to receive job interrupt notifications. Such registration is accomplished via any means known in the art. For example, the designated recipient of the notification message suitably includes an administrator application, the application that originated the job being interrupted, the application or applications with jobs pending following the interrupted job, and other applications that have registered with the job monitor 104.

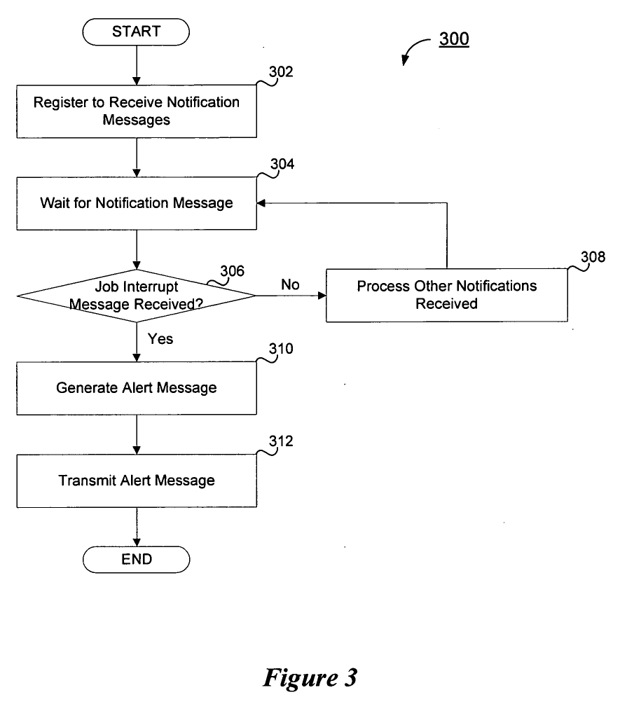

The job monitor 104 then advantageously records the job interrupt in a log. Those skilled in the art will appreciate that the log is any data file known in the art capable of containing information. Preferably, the log file is stored in associated memory of the job monitor 104, or alternatively, associated memory of the document processing device 102. Flow then proceeds to step 216, wherein a determination is made whether additional jobs are still being processed by the document processing device 102. When no additional jobs are being processed, operation terminates. When additional jobs remain to be processed, flow proceeds back to step 202, wherein the job monitor 104 returns to monitoring and tracking the operations of the document processing device 102. The process by which an application functions in accordance with the present invention will best be understood in conjunction with the flow chart described in FIG. 3.

Referring now to FIG. 3, there is shown a flow chart 300 illustrating the registration and notification method employed by applications in accordance with the present invention. Beginning at step 302, the application registers with the job monitor 104 via any suitable means known in the art. Preferably, the registration includes instructions for communicating a notification message to the application, such as, but without limitation, an IP address, a MAC address, an electronic mail address, a user-name, and the like. Following registration, the application waits at step 304 for the receipt of a notification message. Upon receipt of a notification message, flow proceeds to step 306 wherein a determination is made whether the notification indicates that a job interrupt has occurred. When the notification message does not include a job interrupt notification, flow proceeds to step 308, wherein the notification is processed and the application returns to step 304 to wait for another notification message. It will be understood by those skilled in the art that each notification message received by the application is not solely related to the present invention and only those notification messages relating to the interruption of document processing operations on the document processing device 102 are advantageously used in accordance with the present invention.

When a job interrupt notification message is received at step 306, flow proceeds to step 310, wherein the application generates an alert message. As will be understood by those skilled in the art, the alert message suitably informs a user or administrator of the occurrence of a job interrupt. Preferably, the alert message is suitably embodied as an electronic mail message, a popup window message dialog, a text message, and the like. Once generated by the application, the alert message is transmitted to the designated recipient user or administrator at step 312. Preferably, the alert message includes data representing the name of the job interrupted, the nature of the interrupt, the pages processed and the pages remaining to be processed, and the like.

In accordance with the present invention, FIG. 4 shows a template alert message screen 400 illustrating a job interrupt has occurred. As depicted in FIG. 4, the screen 400 is advantageously a popup window, as is known in the art. The screen 400 further includes a message 402 indicating that an interruption in the processing of document processing jobs has occurred at the document processing device 102. As previously addressed, the alert message of screen 400 suitably informs the user or administrator as to the document/job name 404, the nature of the interruption 406, the location of the interruption 408, the number of pages processed completely 410, and the number of copies successfully output 412. As will be understood by those skilled in the art, the fields 404-412 are for example purposes only, and other information relating to the document processing job is equally capable of being displayed by the present invention, without departing therefrom. In addition, the skilled artisan will understand that in some job interrupt occurrences, descriptions less than those shown on the screen 400 are displayed. For example, when the job interrupted was a scan job, the number of copies successfully output 412 would necessarily be blank or not shown.

In one embodiment, when the application that originated the document processing job, or alternatively an administrator application, desires to retry the document processing operation, suitable graphical icons are included in the alert message 400. As shown in FIG. 4, when the originating application or administrator elects to retry document processing operations, the resubmit job icon 414 is suitably selected via any means known in the art. Such resubmission is suitably capable of only including those operations or processes not successfully completed, thereby avoiding reprocessing the entire job when unnecessary. When the recipient application does not desire to retry processing, the cancel icon 416 is suitably selected, thereby indicating the closure of the screen 400 and the cancellation of the pending document processing job.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A document processor error tracking system comprising:
a job monitor associated with a document processor, which job monitor includes means includes adapted for receiving job status data representative of a status of a document processing operation in process on the document processor;
the job monitor further comprising means adapted for receiving a job interrupt signal representative of an interruption in the document processing operation prior to completion thereof;
an alert generator, responsive to the job interrupt signal, the generator including means adapted for generating an alert message including job status data;
means adapted for selectively communicating the alert message to at least one selected destination.

2. The document processor error tracking system of claim 1, wherein the job status data includes at least one data signal from the set comprising:
a job identifier associated with the document processing operation;
data representative of a completion level of the document processing operation; and
data representative of a cause of the job interrupt signal.

3. The document processor error tracking system of claim 2 wherein the at least one selected destination includes at least one destination application from the set comprising:
a user application from which the document processing operation was initiated; and
a management application adapted for receiving job alert signals from a plurality of document processors.

4. The document processor error tracking system of claim 3 wherein the destination application includes means adapted for generating an alert broadcast across a selected network, the alert broadcast including at least one of the group consisting of an alert message to a system administrator, an SNMP alert message, and an alert message to an associated administrative application.

5. The document processor error tracking system of claim 3, further comprising means adapted for storing, in associated log file, at least one of the group consisting of data representative of a cause of the job interrupt signal, data representative of a completion level of the document processing operation, and a job identifier associated with the document processing operation.

6. The document processor error tracking system of claim 5, wherein the cause of the job interrupt signal is at least one of the group consisting of a mechanical error, an electrical error, and a programming error.

7. A method for tracking document processor error comprising the steps of:
receiving job status data representative of a status of a document processing operation in process on the document processor
receiving a job interrupt signal representative of an interruption in the document processing operation prior to completion thereof;
generating an alert message including job status data responsive to the job interrupt signal; and
selectively communicating the alert message to at least one selected destination.

8. The method for tracking document processor error of claim 7, wherein the job status data includes at least one data signal from the set comprising:
a job identifier associated with the document processing operation;
data representative of a completion level of the document processing operation; and
data representative of a cause of the job interrupt signal.

9. The method for tracking document processor error of claim 8 wherein the at least one selected destination includes at least one destination application from the set comprising:
a user application from which the document processing operation was initiated; and
a management application adapted for receiving job alert signals from a plurality of document processors.

10. The method for tracking document processor error of claim 9, further comprising the step of generating an alert broadcast across a selected network, the alert broadcast including at least one of the group consisting of an alert message to a system administrator, an SNMP alert message, and an alert message to an associated administrative application.

11. The method for tracking document processor error of claim 9, further comprising the step of storing, in associated log file, at least one of the group consisting of data representative of a cause of the job interrupt signal, data representative of a completion level of the document processing operation, and a job identifier associated with the document processing operation.

12. The method for tracking document processor error of claim 11, wherein the cause of the job interrupt signal is at least one of the group consisting of a mechanical error, an electrical error, and a programming error.

13. A computer-readable medium of instructions with computer-readable instructions stored thereon for tracking document processor error comprising:
instructions for receiving job status data representative of a status of a document processing operation in process on the document processor
instructions for receiving a job interrupt signal representative of an interruption in the document processing operation prior to completion thereof;
instructions for generating an alert message including job status data responsive to the job interrupt signal; and
instructions for selectively communicating the alert message to at least one selected destination.

14. The computer-readable medium of instructions with computer-readable instructions stored thereon for tracking document processor error of claim 13, wherein the job status data includes at least one data signal from the set comprising:
a job identifier associated with the document processing operation;
data representative of a completion level of the document processing operation; and
data representative of a cause of the job interrupt signal.

15. The computer-readable medium of instructions with computer-readable instructions stored thereon for tracking document processor error of claim 14 wherein the at least one selected destination includes at least one destination application from the set comprising:
a user application from which the document processing operation was initiated; and
a management application adapted for receiving job alert signals from a plurality of document processors.

16. The computer-readable medium of instructions with computer-readable instructions stored thereon for tracking document processor error of claim 15, further comprising instructions for generating an alert broadcast across a selected network, the alert broadcast including at least one of the group consisting of an alert message to a system administrator, an SNMP alert message, and an alert message to an associated administrative application.

17. The computer-readable medium of instructions with computer-readable instructions stored thereon for tracking document processor error of claim 15, further comprising the step of storing, in associated log file, at least one of the group consisting of data representative of a cause of the job interrupt signal, data representative of a completion level of the document processing operation, and a job identifier associated with the document processing operation.

18. The computer-readable medium of instructions with computer-readable instructions stored thereon for tracking document processor error of claim 17, wherein the cause of the job interrupt signal is at least one of the group consisting of a mechanical error, an electrical error, and a programming error.

19. A computer-implemented method for tracking document processor error comprising the steps of:
receiving job status data representative of a status of a document processing operation in process on the document processor
receiving a job interrupt signal representative of an interruption in the document processing operation prior to completion thereof;
generating an alert message including job status data responsive to the job interrupt signal; and
selectively communicating the alert message to at least one selected destination.

20. The computer-implemented method for tracking document processor error of claim 19, wherein the job status data includes at least one data signal from the set comprising:
a job identifier associated with the document processing operation;
data representative of a completion level of the document processing operation; and
data representative of a cause of the job interrupt signal.

21. The computer-implemented method for tracking document processor error of claim 20 wherein the at least one selected destination includes at least one destination application from the set comprising:
a user application from which the document processing operation was initiated; and
a management application adapted for receiving job alert signals from a plurality of document processors.

22. The computer-implemented method for tracking document processor error of claim 21, further comprising the step of generating an alert broadcast across a selected network, the alert broadcast including at least one of the group consisting of an alert message to a system administrator, an SNMP alert message, and an alert message to an associated administrative application.

23. The computer-implemented method for tracking document processor error of claim 21, further comprising the step of storing, in associated log file, at least one of the group consisting of data representative of a cause of the job interrupt signal, data representative of a completion level of the document processing operation, and a job identifier associated with the document processing operation.

24. The computer-implemented method for tracking document processor error of claim 23, wherein the cause of the job interrupt signal is at least one of the group consisting of a mechanical error, an electrical error, and a programming error.
